(19) United States
(12) Patent Application Publication
(10) Pub. No.: US 2011/0279348 A1
(43) Pub. Date: Nov. 17, 2011

(54) ANTENNA DEVICE

(75) Inventors: Golam Sorwar HOSSAIN, Hawasaki (JP); Takashi Yamagajo, Kawasaki (JP)

(73) Assignee: FUJITSU LIMITED, Kawasaki-shi (JP)

(21) Appl. No.: 13/076,710

(22) Filed: Mar. 31, 2011

(30) Foreign Application Priority Data
May 12, 2010 (JP) 2010-110572

(51) Int. Cl. H01Q 1/36

(52) U.S. Cl. 343/895

(57) ABSTRACT

An antenna device includes an antenna element having an external form shaped into a substantially rectangular-shaped planar spiral coil and a switch provided to the antenna element.

### CROSS-REFERENCE TO RELATED APPLICATIONS

This application is based upon and claims the benefit of priority of the prior Japanese Patent Application No. 2010-110572, filed on May 12, 2010, the entire contents of which are incorporated herein by reference.

### FIELD

The present invention relates to an antenna device.

### BACKGROUND

A device for wireless communication is, for example, an electronic apparatus having a wireless communication function. The electronic apparatus may specifically include a wireless terminal such as a mobile phone, a smart phone, a PDA (Personal digital Assistant), a PC (Personal Computer) or a GPS (Global Positioning System) terminal, or a wireless communication application apparatus such as a card for wireless communication (e.g., a PCMCIA card).

A recent trend in the field of devices for wireless communication is a device for multi-band or wideband wireless communication which uses a plurality of radio frequency bands. Design of such a device for wireless communication, particularly a wireless terminal, is growing more and more complicated year by year, and an antenna element put in the device is desired to be made as small as possible.

### SUMMARY

According to an aspect of the embodiment, an antenna device includes an antenna element having an external form shaped into a substantially rectangular-shaped planar spiral coil and a switch coupled to the antenna element.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an exemplary structure of an antenna device of an embodiment and a printed board to which the antenna device is fixed;

FIG. 2A schematically illustrates a plan view of the antenna device illustrated in FIG. 1;

FIG. 2B schematically illustrates a side view of the antenna device illustrated in FIG. 1;

FIG. 3 illustrates an antenna device of another embodiment;

FIG. 4A illustrates a current density distribution on an antenna device having neither a switch nor a bias line;

FIG. 4B illustrates a current density distribution on an antenna device of a first embodiment;

FIG. 5 is a graph for illustrating a result of simulating an S-parameter (return loss) for signals in a 0.5-6 GHz frequency range in conditions where impedance matching of an antenna device is not achieved;

FIG. 6A illustrates a result of simulating an S-parameter (return loss) in the 0.5-6 GHz frequency range in conditions where impedance matching of the antenna device of the first embodiment is achieved.

FIG. 6B illustrates the result illustrated in FIG. 6A by expanding a 0.5-1.1 GHz frequency range.

FIG. 7 illustrates a result of simulating a return loss in conditions where switches are kept in an unchanged state and an angle θ (an external form of the antenna element) between an antenna element and the printed board illustrated in FIG. 2A is changed.

### DESCRIPTION OF EMBODIMENTS

An advantage of some aspects of an embodiment of the invention is to provide an antenna device which can occupy a small volume and can change an antenna characteristic.

An embodiment of the invention is an antenna device including an antenna element having a substantially rectangular-shaped planar spiral coil and a switch connected to the antenna element.

According to the embodiment of the invention, an antenna device which can occupy a small volume and can change an antenna characteristic can be provided.

An embodiment of the invention will be explained with reference to the drawings. A structure of the embodiment described below is exemplary only, and the invention is not limited to the structure of the embodiment.

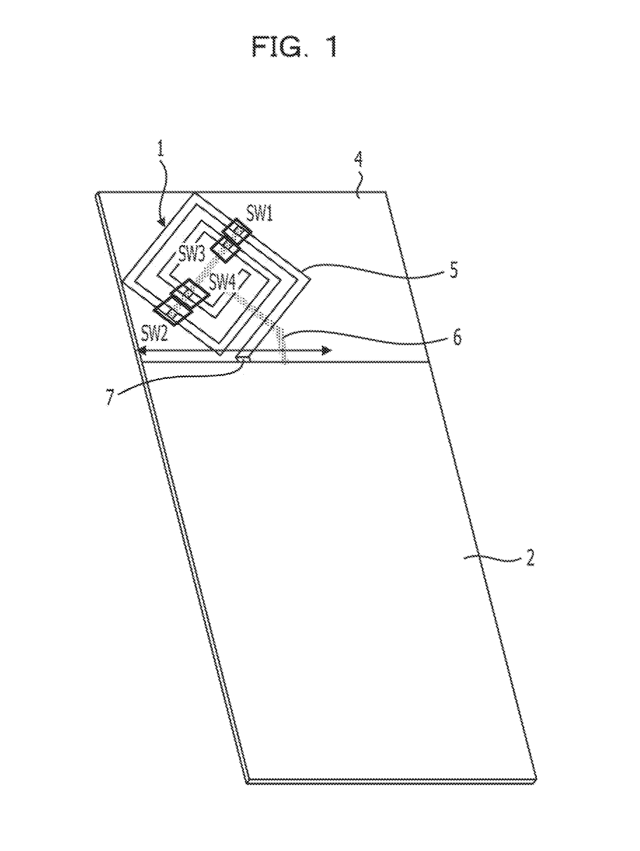

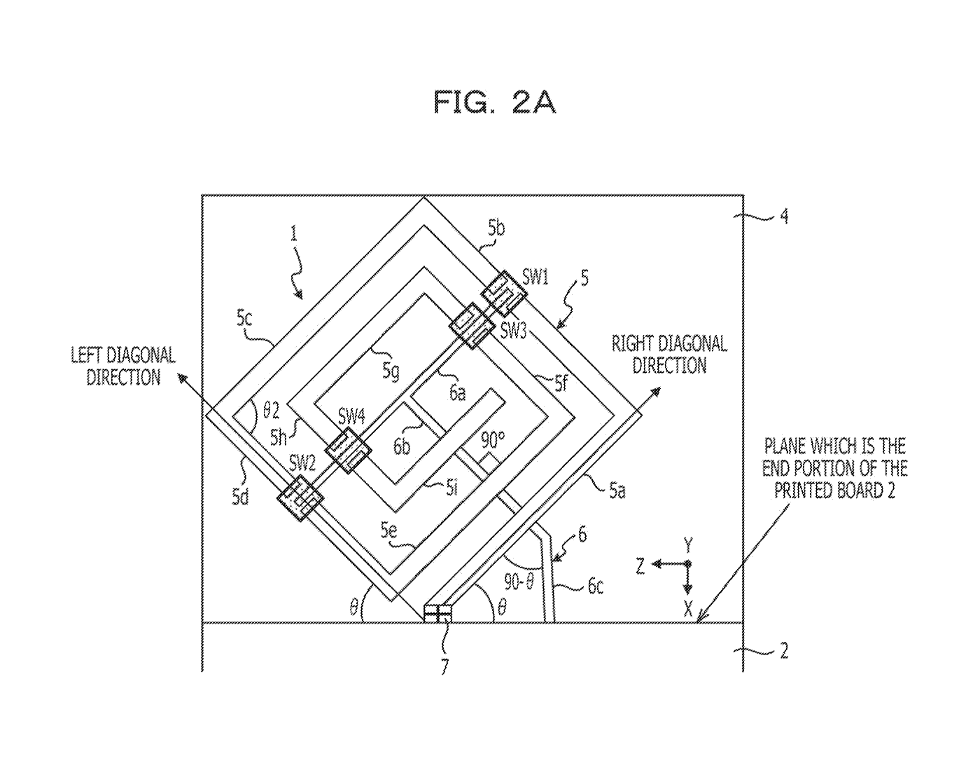

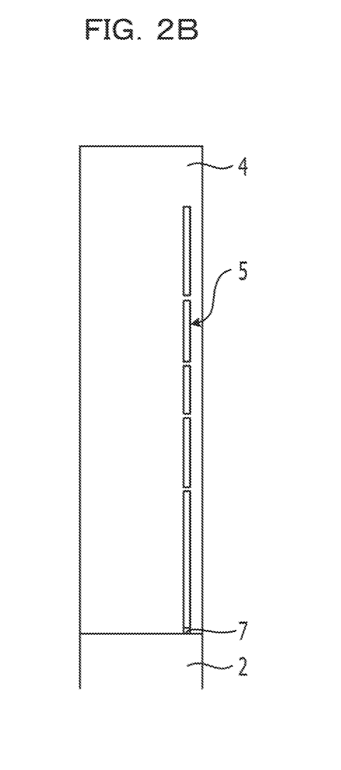

FIG. 1 illustrates an externally viewed structure of a wireless communication device having an antenna device. FIG. 2A is a plan view of the antenna device illustrated in FIG. 1. FIG. 2B is a side view of the antenna device illustrated in FIG. 1.

As illustrated in FIG. 1, the antenna device 1 is a planar monopole antenna provided from an end portion of a printed board 2 in one direction of the printed board 2 (a longer side direction of the printed board in FIG. 1) and in a direction of the plane of the printed board 2. The antenna device 1 is contained in a substrate material 4 having a suitable value of relative permittivity. The antenna device 1 is provided in a same direction as the direction of the plane of the printed board 2, so that an effect (mixed noise, etc.) caused by an electronic circuit mounted on the printed board 2 can be reduced.

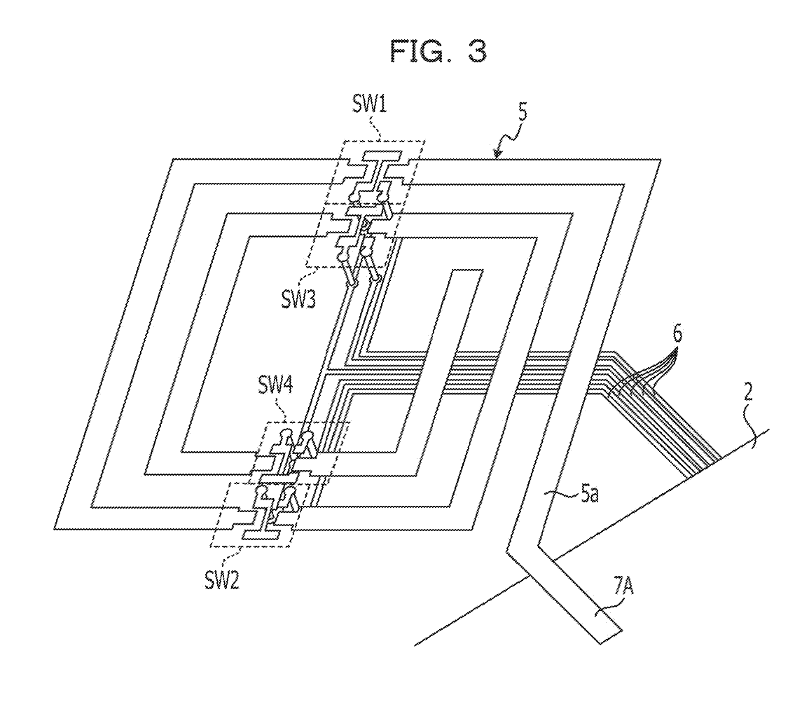

As illustrated in FIGS. 2A, 2B, and 3, the antenna device 1 has an antenna element 5, a plurality (four, e.g., in FIGS. 1-3) of switches SW1, SW2, SW3, and SW4 (these switches are called, if collectively, “switches SW”, hereafter), and a bias line 6 (wiring) which supplies DC currents for driving the switches SW.

As illustrated in FIG. 2A, the antenna element 5 has a planar shape as a whole such that a ribbon-like antenna conductor coils into a substantially rectangular-shaped planar spiral coil. As illustrated in FIG. 2B, the substantially rectangular-shaped planar spiral coil is put on one plane. Incidentally, the bias line 6 is not illustrated in FIG. 2B in an effort to simplify the drawing. The substantially rectangular-shaped planar spiral coil is formed by a plurality of straight portions (antenna arms) 5a-5i. Each of the straight portions from 5b, next to the straight portion 5a, to 5i turns by a certain angle counterclockwise in the drawing, so that the substantially rectangular-shaped planar spiral coil is formed such that the ribbon-like conductor is wound twice. The respective straight portions 5a-5i are separated by a certain distance from one another so as to avoid mutual contact. An end of the straight portion 5i is located in the middle of the antenna element 5.

An end of the straight portion 5a is connected to an RF circuit through a feeding point 7 and an impedance matching circuit mounted on the printed board 2 but not illustrated. Directions in which the straight portions 5a and 5d which make a fringe of the antenna element 5 on a side facing the printed board 2 are extended (the direction in which the straight portion 5a is extended (from lower left to upper right) and the direction in which the straight portion 5d is extended (from lower right to upper left) in FIG. 2A) are arranged to in at a certain angle θ for a plane (straight line) which is the end portion of the printed board 2 individually.

The switches SW1, SW2, SW3, and SW4 are inserted in the middle of the straight portions 5b, 5d, 5f and 5h, respectively, of the antenna element 5 in such a manner as to form a straight line. As illustrated in FIG. 2A, the straight line formed by SW1, SW2, SW3, and SW4 is parallel to straight portion 5a. Each one of the switches SW may be comprised of a semiconductor switch, and may be turned on upon being supplied with a dc from the bias line 6. Upon the switches SW1-SW4 being turned on, the antenna element 5 (antenna arm) changes its length.

The bias line 6 is located on the back of the antenna element 5 in FIG. 2A. The bias line 6 is formed by a first portion 6a located in a direction perpendicular individually to the straight portions 5b, 5d, 5f, and 5h in which the switches SW are inserted. A second portion 6b of the bias line 6 extends from the middle of the first portion 6a toward the printed board 2 in a direction perpendicular to the first portion 6a. A third portion 6c of the bias line 6 connects an end of the second portion 6b to the printed board 2. The third portion 6c crosses the straight portion 5a at an angle of (90 degrees minus θ). As describes above, the portions of the bias line 6 which overlap the antenna element 5 are located in a direction perpendicular to the respective straight portions of the antenna element 5. The antenna element 5 is thereby prevented from getting mixed with noise caused by a current which flows through the bias line 6.

FIG. 3 illustrates an antenna element 5 of another embodiment. The antenna element 5 exemplarily illustrated in FIGS. 2A and 2B is provided in such a way as to stand at a certain location within the thickness of the printed board 2. As exemplarily illustrated in FIG. 3, meanwhile, the straight portion 5a is integrated with a ribbon-like feeder line 7A which is fixed on one plane of the printed board 2.

The bias line 6 has lines for supplying on-signals (DC) connected to the respective switches SW and a ground line provided commonly to the switches SW1-SW4. The bias line 6 is connected to a control circuit (not illustrated) of the switches SW provided on the printed board 2. The switches SW1-SW4 can be individually turned on or off as controlled by the control circuit.

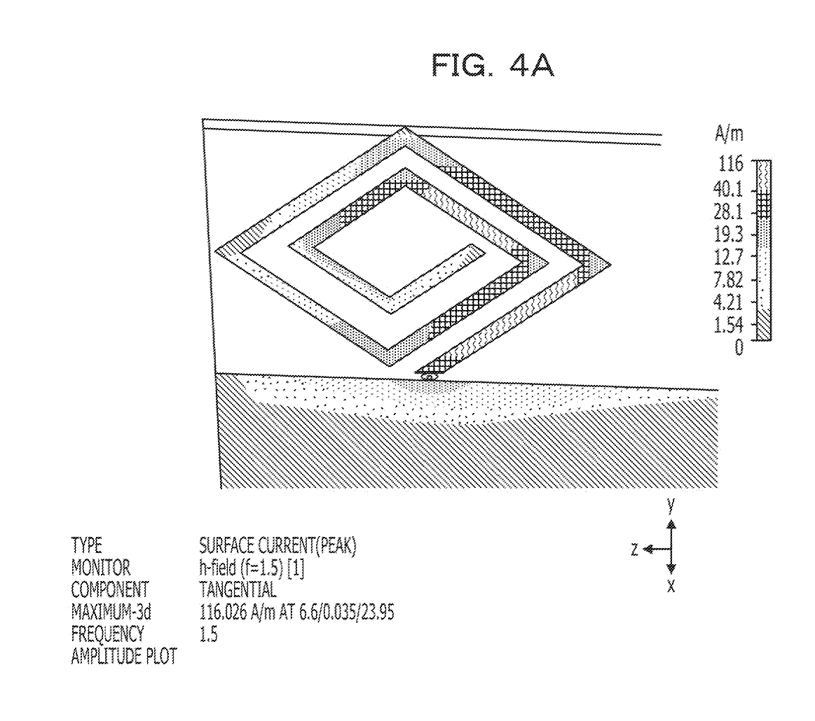

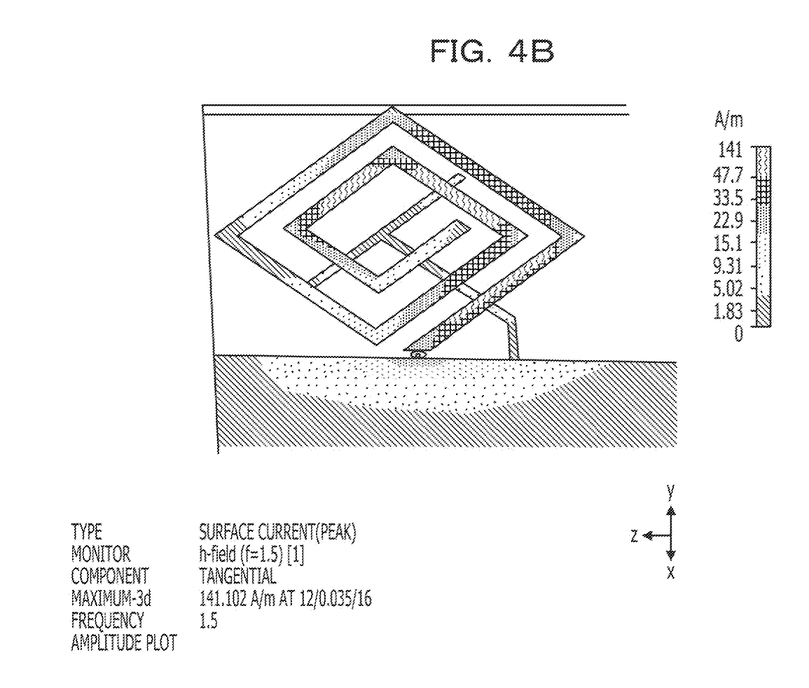

FIGS. 4A and 4B illustrate surface current density distributions on antenna elements radiating a radio wave of 1.5 GHz. FIG. 4A illustrates a result of simulating a surface current density distribution on an antenna element provided with neither the bias line 6 nor the switches SW. FIG. 4B illustrates a result of simulating a surface current density distribution on the antenna element 5 of the first embodiment provided with the bias line 6 and the switches SW. As illustrated in FIG. 4B, for example, all the switches SW are on. As illustrated in FIGS. 4A and 4B, the antenna element illustrated in FIG. 4B includes broader portions of higher current density than that illustrated in FIG. 4A. The antenna device 1 of the first embodiment has a fine radiation characteristic.

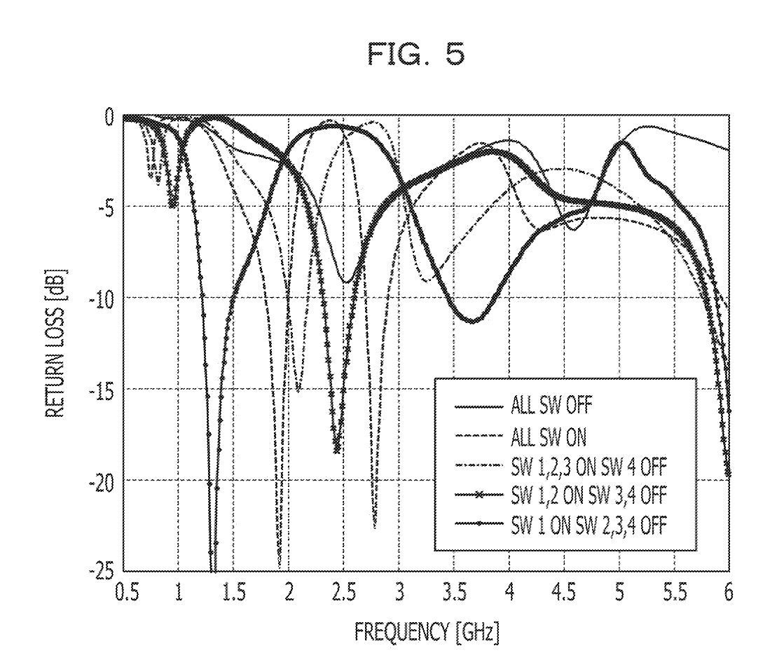

FIG. 5 is a graph for illustrating a result of simulating an S-parameter (return loss) for signals in a 0.5-6 GHz frequency range in conditions where impedance matching of the antenna device 1 is not achieved. FIG. 5 illustrates return losses in cases where all the switches SW1-SW4 are off, all the switches SW1-SW4 are on, the switches SW1-SW3 are on and the switch SW4 is off, the switches SW1 and SW2 are on and the switches SW3 and SW4 are off, and the switch SW 1 is on and the switches SW2-SW4 are off.

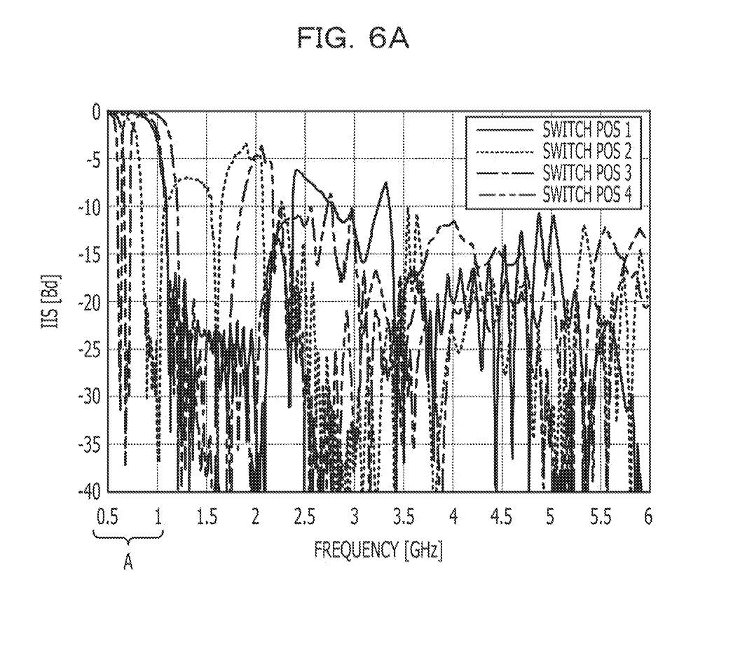

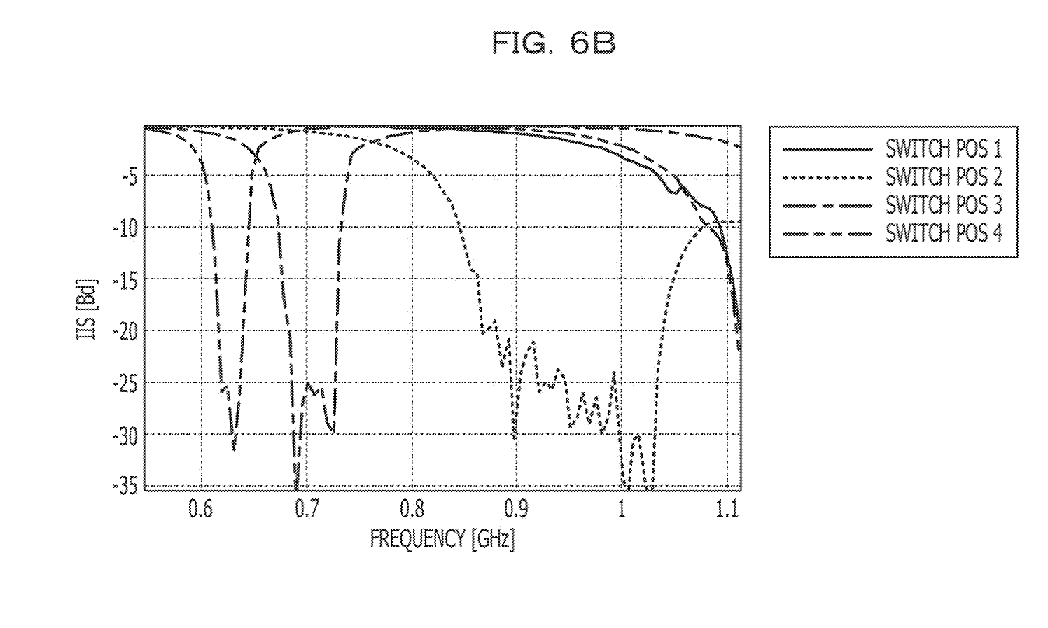

FIG. 6A illustrates a result of simulating an S-parameter (return loss) for signals in the 0.5-6 GHz frequency range in conditions where impedance matching of the antenna device 1 of the first embodiment is achieved. FIG. 6B illustrates that result by expanding a 0.5-1.1 GHz frequency range (part A in FIG. 6A). A matching circuit formed by an inductor (L) and a capacitor (C) for the simulation is applied for impedance matching, where the values L and C are set in the ranges of L=1-10 nH and C=0.25-6 pF.

In FIGS. 6A and 6B, switch positions 1, 2, 3, and 4 correspond to cases where the switch SW1 is on and the switches SW2-SW4 are off, the switches SW1 and SW2 are on and the switches SW3 and SW4 are off, the switches SW1-SW3 are on and the SW4 is off, and the switches SW1-SW4 are on, respectively.

As illustrated in FIG. 6A, zones of small return losses are formed in the 0.5-6 GHz frequency range by means of the on-off control of the switches SW1-SW4, and it is thereby known that a wideband antenna which can be preferably used in those frequency bands can be obtained. As illustrated in FIG. 6B, it is further known that zones of small return losses can be obtained in the respective frequency ranges of 0.62-0.65 GHz, 0.68-0.73 GHz and 0.88-1.03 GHz. It is thereby known that the antenna device 1 can be used also in the 0.6-1.1 GHz frequency range.

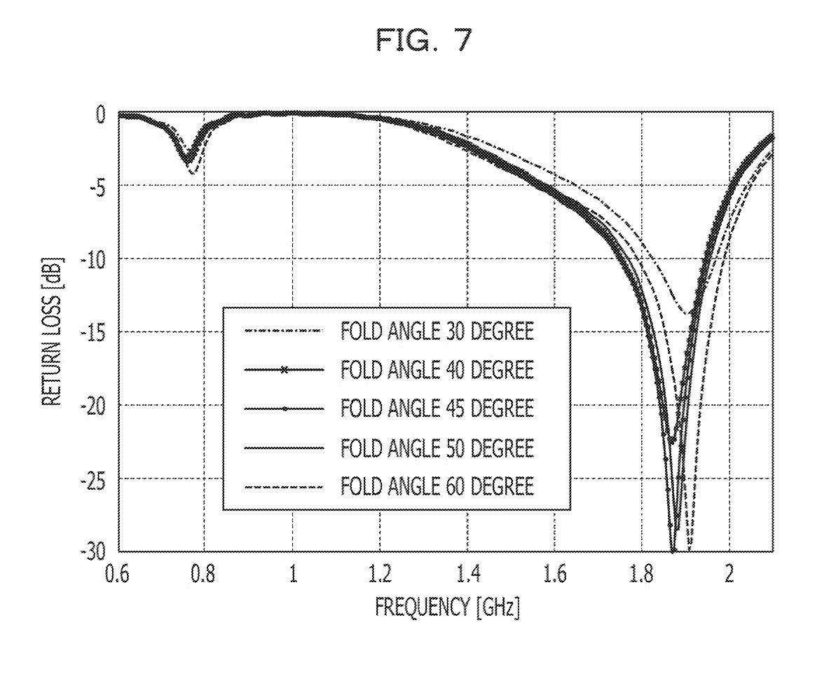

FIG. 7 illustrates a result of simulating a return loss in conditions where the switches SW are kept in an unchanged state and the angle θ (fold angle) between the antenna element 5 and the printed board 2 (see FIG. 2A) is changed. As illustrated in FIG. 7, the return losses are measured for the angles θ of 30, 40, 45, 50, and 60 degrees. FIG. 7 illustrates an example in a case where the angles θ on the right and left sides in FIG. 2A are equal to each other. Incidentally, when θ=30 degrees, an interior angle θ2 of the diamond shape formed by the antenna element 5 in the horizontal direction in FIG. 2A (see FIG. 2A) is 60 degrees. When θ=40, 45, 50 and 60 degrees, the interior angle θ2=80, 90, 100 and 120 degrees, respectively. When θ=45 degrees, the external form of the antenna element 5 is a square.

As the results illustrated in FIG. 7 demonstrate, the antenna device 1 can have acceptable return losses for use for the respective values in the range of θ=30-60 degrees. The lowest return loss is obtained, in particular, when θ=45 degrees. It is known that the external form of the antenna element 5 should preferably be a square, i.e., θ=45 degrees. For θ=50 or 60 degrees, meanwhile, the antenna element 5 grows longer in the direction of height (top to bottom direction in FIG. 2A) and grows larger in terms of the volume occupied by the antenna device 1 (grows longer in the longer side direction in combination with the printed board 2). It is thereby known that the condition of θ=45 degrees is most preferable in the above result from viewpoints of the return loss and the size of the antenna element.

According to the above embodiments, the substantially rectangular-shaped planar spiral coil antenna element 5 is provided with the plural switches SW1-SW4, the antenna element changes its length by means of the on-off operations of the switches SW1-SW4, and the antenna element 5 is consequently in a state of having different antenna characteristics (return loss characteristics). That leads to an antenna device of reconfigurable antenna characteristics. An antenna of a small return loss in a desirable frequency band can thereby be obtained by means of the on-off operations of the switches SW1-SW4. As the zones of small return losses span the broadband of 0.6-6 GHz, the antenna device 1 can be used as a wideband antenna which can be applied to that broadband.

Further, as the external form of the antenna element 5 is diamond-shaped (square), the volume occupied by the antenna device 1 can be reduced and, meanwhile, a desirable antenna length can be obtained. Incidentally, the external form of the antenna element 5 can be a parallelogram or a rectangle as long as a desirable return loss characteristic can be obtained. Further, the angles θ at which the antenna element is fixed to the printed board 2 on the right and left sides with respect to the feeding point 7 (FIG. 2A) can be of different values. Further, the wiring state of the bias line 6 can be suitably changed as long as a desirable return loss characteristic can be obtained. Further, although the antenna device 1 is fixed to the printed board 2 on the same plane, the angle at which the antenna device 1 is fixed to the printed board 2 can be suitably set.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device comprising:
an antenna element having an external form shaped into a substantially rectangular-shaped planar spiral coil; and
a first switch coupled to the antenna element.

2. The antenna device according to claim 1, wherein:
the antenna element has a first end located on a vertex of the rectangular-shaped planar spiral coil and a second end located on a middle portion of the antenna element; and
the first end of the antenna element is fixed to a printed board in such a way that each of two portions of the antenna element located individually on two sides including the vertex crosses a straight fringe of the printed board at an angle θ.

3. The antenna device according to claim 2, wherein the angle θ is between 30 and 60 degrees.

4. The antenna device according to claim 1, further comprising extra second switch which can be turned on or off separately from the first switch.

5. The antenna device according to claim 1, further comprising a line which supplies the first switch with an on-off signal, the line being located in a direction perpendicular to a straight portion of the antenna element.
